(19) United States
(12) Patent Application Publication
(10) Pub. No.: US 2013/0186928 A1
(43) Pub. Date: Jul. 25, 2013

(54) DEVICE FOR DRIVING A FIXING ELEMENT

(71) Applicant: Bryan Nigel Victor Parsons, Warwickshire (GB)

(72) Inventor: Bryan Nigel Victor Parsons, Warwickshire (GB)

(73) Assignee: NAIL SEAL LIMITED, Birmingham (UK)

(21) Appl. No.: 12/532,721

(22) PCT Filed: Mar. 23, 2007
(86) PCT No.: PCT/GB07/01074

§ 371 Date: Dec. 15, 2009

(51) Int. Cl. B27F 7/02

(52) U.S. Cl. CPC B27F 7/02
USPC 227/14

(57) ABSTRACT

A gun device for driving a fixing element into a work surface includes a driving mechanism for the fixing element. The gun device further includes supply means for a filler material, the supply means having an outlet arranged to deposit filler material on the work surface at a point corresponding substantially to an entry point of the fixing element into the work surface. Actuating means is provided for actuating the supply means in response to advancement of the gun device towards the work surface to deposit filler material on the work surface. Movable means is provided, movable in response to retreat of the gun device from the work surface, to pass across the work surface over the end of the fixing element so as to cause deposited filler material to smooth and fill any depression formed in the work surface as a result of operation of the gun device.

### BACKGROUND OF THE INVENTION

This invention relates to a device for driving a fixing element into a work surface, for example a constructional material. The device may be used for driving fixing elements such as nails into wood, and more particularly but not exclusively the invention relates to a nail gun for use such as in the construction of pallets and crates, fixing of floor boarding, manufacture of furniture and the fixing of trim and architraves.

When using machines of the above type, the depression left in the material when the nail is driven to the required depth can be unacceptably unsightly. To improve the finish, the depressions might be filled with a wood-filler which could require further dressing when cured. This is a labor-intensive operation which increases the cost of the process.

It is an object of the present invention to provide a device for driving a fixing element into a work surface and simultaneously for filling any depression formed in the material as the fixing element is inserted.

### SUMMARY O INVENTION

According to the present invention there is provided a gun device for driving a fixing element into a work surface and including a driving mechanism for driving a fixing element into the work surface, characterised in that the gun device further includes: supply means for a filler material, the supply means having an outlet arranged to deposit filler material on the work surface at a point corresponding substantially to an entry point of the fixing element into the work surface; means for actuating the supply means in response to advancement of the gun device towards the work surface to deposit filler material on the work surface; and means movable in response to retreat of the gun device from the work surface to pass across the work surface over the end of the fixing element so as to cause deposited filler material to smooth and fill any depression formed in the work surface as a result of operation of the gun device.

The supply means may comprise a piston pump dispenser including a body attached to the remainder of the device, piston means biased to an extended configuration, and a reservoir. Thus, as the device approaches the work surface the piston is depressed and filler material in the dispenser is displaced and deposited on the work surface substantially at the point of entry of the fixing element into the work surface such that, in use, the fixing element passes through the filler material and draws a portion thereof into the work surface. The energy required for operation of the piston pump is derived from work done by the user of the device in bringing the device into close proximity to the work surface.

The means for actuating the supply means may comprise a shaft which protrudes from the remainder of the dispenser to contact the work surface. In this way, the contact and the relative motion between the shaft and the remainder of the dispenser causes operation of the dispenser. The shaft may be hollow for the passage of filler material to the outlet. A one-way valve may be incorporated into the piston to inhibit the flow of filler material from the outlet back into the supply means. In this way, return motion of the piston under the unrestrained action of spring loading may induce flow from a reservoir of filler material.

The piston pump dispenser may include a spill port which is covered by the piston means during part of its travel such that on initial movement of the piston means the spill port is open and filler material flows back to a reservoir, while on further movement the piston means closes the spill port and filler material is dispensed through the outlet. The reservoir may be made of a flexible material, for example contained within a substantially rigid frame. This allows the reservoir to accommodate the change in volume associated with the action of the dispenser and allows the reservoir to exclude gases therefrom.

The supply means may be operated on advancement of the device as a result of contact with the work surface.

An axial direction of the outlet may be inclined to a direction of movement of the fixing element from the device into the work surface. The axial direction of the outlet may intersect with the direction of movement of the fixing element. Thus the outlet dispenses the filler material onto the work surface at a position substantially in the path of the fixing element during operation of the device. Thus, the stroke of the dispenser piston together with the angle of inclination of the outlet relative to the path of the fixing element may determine the distance moved by the outlet across the work surface. Such movement may wipe the filler material into any depression caused by the action of the device.

The outlet of the supply means may be movable in response to retreat of the gun device from the work surface so as to cause deposited filler material to fill any depression. Thus, after operation, as the device is raised from the work surface in a direction substantially normal thereto, the motion of the outlet, for example under the influence of a biasing spring, may maintain contact with the work surface so as to wipe across any depression formed in the work surface and to fill the same.

Alternatively, the means movable in response to retreat of the device may be selected from a wiper and a roller. The movable means may be movable such that, on advancement of the device towards the work surface, the movable means is retracted from a first position in which it extends across a direction of movement of the fixing element from the device into the work surface to a second position in which the movable means is clear of the direction of movement and, on retreat of the device from the work surface, the movable means is advanced from the second position to the first position so as to cause deposited filler material to fill any depression. As the movable means is moved between the first and second positions the movable means may be moved initially towards and subsequently away from the work surface. The movable means may be moved along an arcuate path.

The movable means may be movable by means selected from a cam mechanism, a rack and pinion assembly and a worm drive which is operated as the device is advanced towards and retracted from the work surface.

The movable means may be made of a flexible material, such as a resilient material. The movable means may be made of a material having a low coefficient of friction and/or may be coated with a material having a low coefficient of friction.

The wiper may be formed with a waisted portion to increase flexibility thereof. Biasing means may be provided to urge the movable means towards the work surface.

The filler material may be formulated to change from a substantially liquid state in the reservoir to a solid state after being dispensed. In order to prevent the filler material hardening in the outlet, the outlet may incorporate a one-way valve which allows the passage of filler material under the action of internal pressure, but otherwise provides an air-tight seal. In this way the outlet is sealed between use so as to prevent access to air and moisture and the loss of volatile constituents of the filler material.

A guard may be provided to surround the filler material deposited on the work surface. The guard may be at least in part flexible. The outlet may form part of the guard at the time the fixing element is driven into the work surface. Such a guard may assist in the prevention of splattering of the filler material when the fixing element passes through the filler material at high speed.

The movable means may be located in a movable foot of the device. A surface of the foot adapted to contact the work surface may be provided with a non-slip surface. The movable foot may be substantially U-shaped. The outlet may extend into an open side of the U-shaped foot.

The whole of the dispenser for the filler material may be made as a disposable item which is replaced when the filler material is exhausted. Such a disposable item may also include the guard. Alternatively, the dispenser may incorporate a disposable reservoir of filler material for attachment to the remainder of the dispenser. The dispenser itself may then be replaced after several reservoirs have been attached.

### BRIEF DESCRIPTION OF DRAWINGS

For a better understanding of the present invention and to show more clearly how it may be carried into effect reference will now be made, by way of example, to the accompanying drawings in which:

FIGS. 1 to 3 show the basic elements of one embodiment of a device for driving fixing elements, in the form of a nailgun, according to the present invention;

FIGS. 4 to 7 show an operating sequence of a dispenser piston relative to a nailgun mechanism;

FIGS. 8 and 9 are a cross-sectional view and an elevational view of a dispenser pump, FIG. 8 being a section taken along the line A-A in FIG. 9;

FIGS. 10 and 11 are cross-sectional views corresponding to FIG. 8 and illustrate the operation of a spill valve arranged on the dispenser pump of FIGS. 8 and 9;

FIG. 12 is a cross-sectional view corresponding to FIG. 8 and illustrates a reservoir attached to a filler dispenser;

FIGS. 13 to 16 illustrate the operation of a wiper mechanism attached to a filler dispenser;

FIGS. 17 to 19 illustrate a guard attached to the wiper mechanism of FIGS. 3 to 16;

FIGS. 20 and 21 show a nozzle tip of a dispenser co-operating with a flexible guard to provide a sealed surround for filler at the instant or activation of the nailgun;

FIGS. 22 and 23 show a sealing device for filler material;

FIG. 24 is a diagrammatic perspective view of a part of another embodiment of a device for driving fixing elements, in the form of a nailgun, according to the present invention;

FIG. 25 is a perspective view from above of a foot of the nailgun shown in FIG. 24;

FIG. 26 is a perspective view from below of the nailgun foot shown in FIG. 25; and

FIG. 27 is an elevational view of a wiper blade for use in the nailgun of FIGS. 24 to 26.

### DETAILED DESCRIPTION OF INVENTION

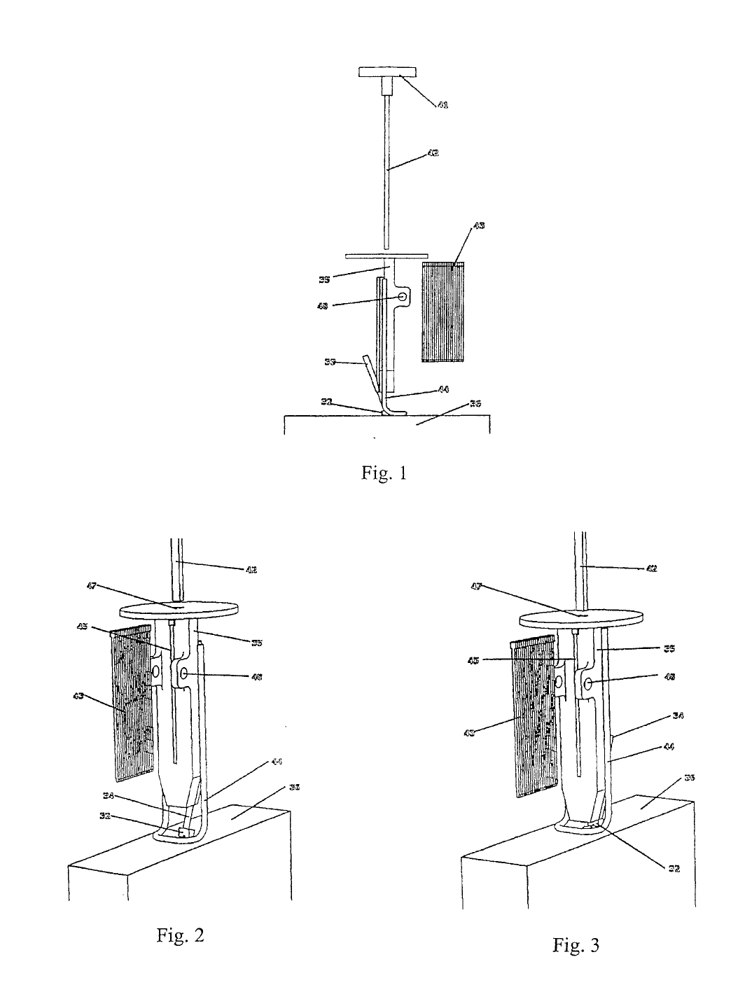

FIGS. 1 to 3 show important features of a conventional nailgun, in which nails 43 are formed into a strip to be fed through a slot 45 in a gun barrel 35 from a magazine (not shown) held by mounting holes 48. A drive pin 42 is powered by piston 41 by gas pressure applied to the upper surface of the piston 41, the flow of gas being regulated by a first trigger mechanism (not shown). A second, interlocking trigger mechanism is attached to a movable foot 44 so that, in order for the nailgun to operate, both trigger mechanisms must be activated. This is a well-known safety feature and prevents accidental firing of the nailgun.

The foot 44 is spring loaded to an extended position, as shown in FIG. 2. In order to activate the trigger mechanism, the foot 44 must be depressed as shown in FIG. 3 so that the end of the nailgun barrel 35 is brought close to a wooden block 36.

In accordance with the present invention, when the two trigger mechanisms are activated, the drive pin 42 moves down through an orifice 47 in barrel 35 to position a dispenser nozzle 34 substantially on an inclined line intersecting the axis of the orifice 47 and hence the axis of motion of the nail 43 when driven. The dispenser nozzle 34 is spring loaded to an extended position as shown in FIG. 2. A shoe 32 is mounted on the end of the dispenser nozzle 34 to guide filler from the dispenser nozzle onto the surface of the wooden block 36. As the nailgun is brought close to the wooden block 36 to depress the foot 44 and activate an interlock trigger, the motion activates a dispenser (not shown in FIGS. 1 to 3) causing filler material to be deposited through the dispenser nozzle 34 onto a surface of the wooden block 36 in the path of the driven nail such that the nail 43 passes through the filler material and draws a portion of the filler material into the wooden block 36.

The filler material is designed to change from a substantially liquid state prior to being dispensed to a solid state after being dispensed.

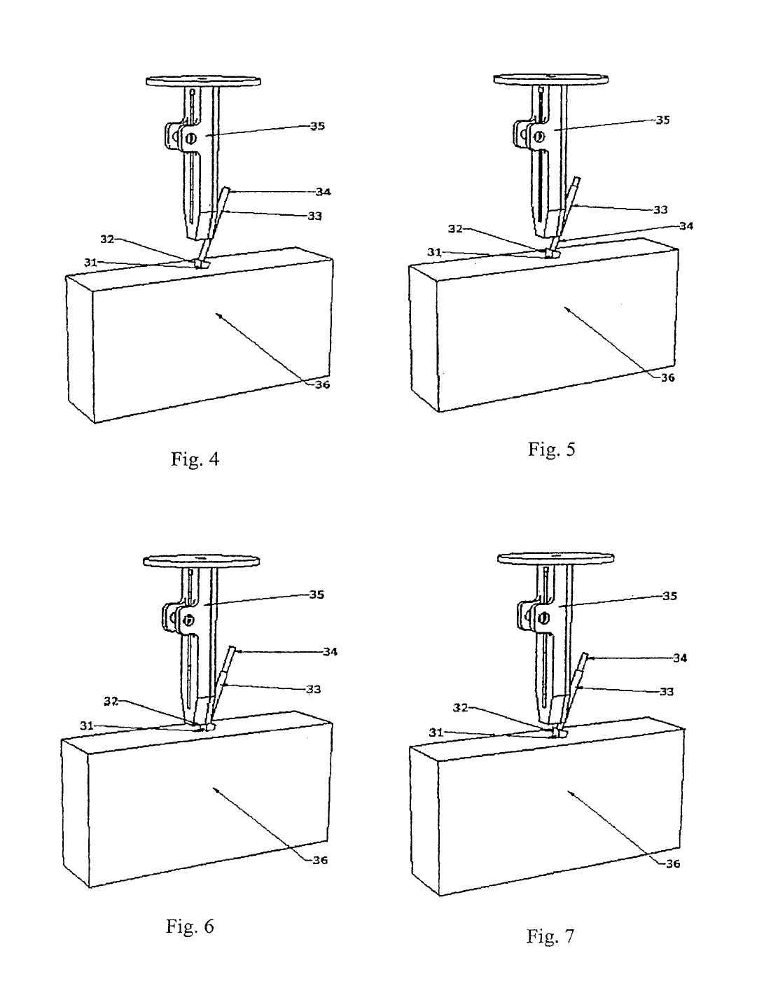

FIGS. 4 to 7 show the motion of the dispenser nozzle 34 and the shoe 32 as the nailgun barrel 35 is moved in a direction perpendicular to the surface of the wooden block 36. A nail site 31 is shown to indicate the intended position of the nail. FIG. 4 shows that initially the shoe 32 is pressed against the wooden block 36 by spring force from the dispenser (not shown in FIGS. 4 to 7). The shoe 32 covers the nail site 31. As the nailgun moves to the position shown in FIG. 5, the nozzle moves along an inclined guide 33 and the shoe 32 moves across the surface of the wooden block 36 away from the nail site 31. The motion of the nozzle 34 causes the dispenser pump to activate and filler material is deposited on the surface of the wooden block 36 on or close to the nail site 31. FIG. 6 shows a configuration in which the barrel 35 is closer to the wooden block 36 than in FIG. 5 so that more of the nail site 31 is uncovered by the shoe 32. FIG. 7 shows the nozzle 34 fully depressed at a point where the foot 44 (not shown in FIGS. 4 to 7) has activated the interlocking trigger and the nailgun is ready to fire. The dispenser has delivered a desired quantity of filler to the surface of the wooden block 36. The nailgun is then activated and the nail is fired into the wooden block 36. As the nailgun is moved away from the wooden block 36 after firing, the shoe 32 maintains contact with the wooden block 36 and slides back over the nail site 31. The action of the shoe 32 causes the filler material in the vicinity of the nail site 31 to be smoothed into the cavity (depression) formed by the nail in the wooden surface 36.

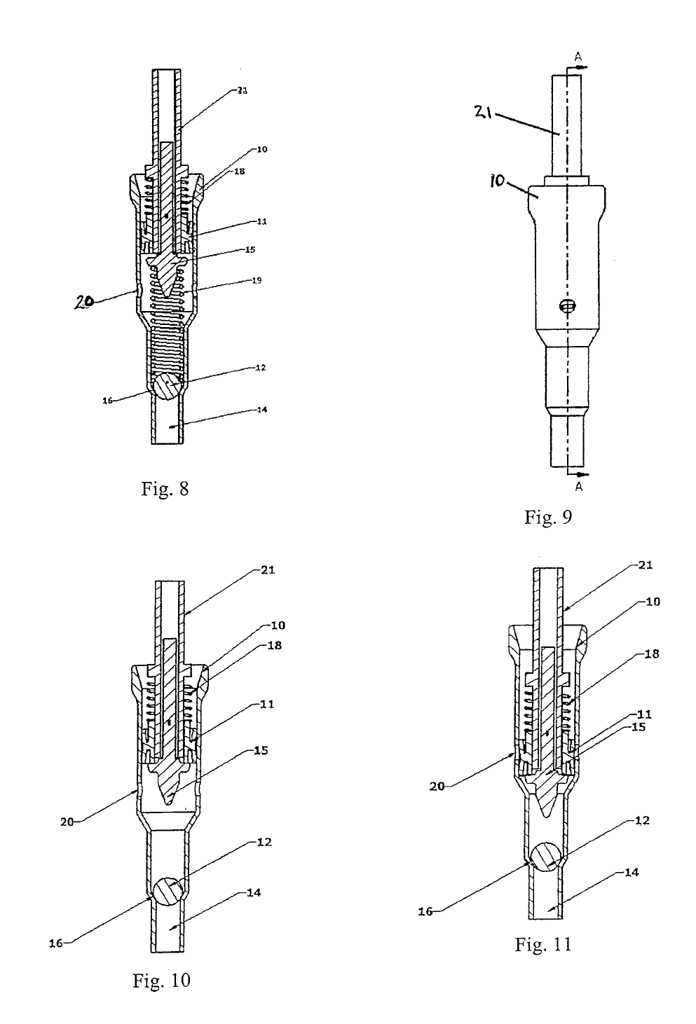

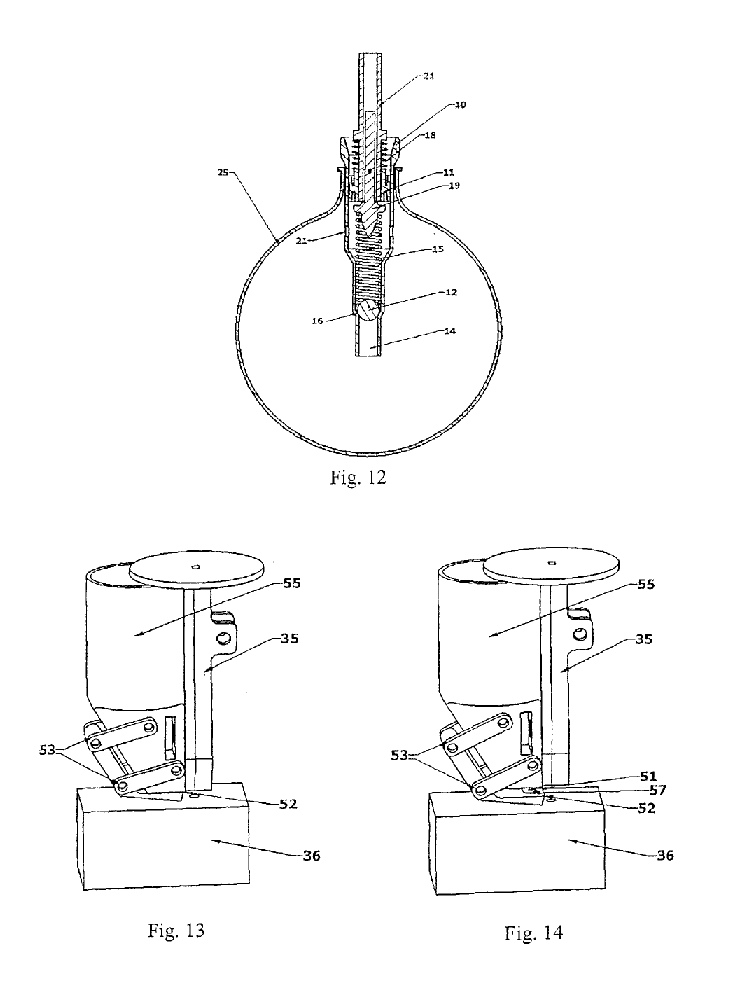

FIGS. 8 and 9 show the filler dispenser in section and in elevation. A dispenser outlet 21 is connected to the nozzle 34 of FIGS. 4 to 7. The dispenser outlet 21 is a hollow tube rigidly attached to a pintle 15 which is attached to a return spring 19. The pintle 15 is connected to the dispenser outlet 21 so that filler material might flow through the annular gap therebetween, provided that a piston 11 is not abutting the pintle 15 and thus sealing the passage. The piston 11 is slidingly mounted on the dispenser outlet 21 and is urged against a back face of the pintle 15 by a piston spring 18, thus closing a connection between filler in the body of a dispenser 10 and the dispenser outlet 21. When the pressure in the body of the dispenser 10 exceeds a pressure determined by the piston spring 18, the piston 11 moves away from the back of the pintle 15 allowing filler material to pass through the dispenser outlet 21. A spill hole 20 and an inlet 14 are connected to a reservoir 25 (FIG. 12). As the dispenser outlet 21 is depressed, the piston spring 18 moves the piston 11 down the body of the dispenser 10. The piston 11 is in contact with the pintle 15, sealing the dispenser outlet 21. This motion causes filler material to flow from the dispenser body 10 through the spill hole 20 and back to the reservoir 25.

Backflow through the inlet 14 is prevented by a check ball 12 which engages a seat 16.

FIGS. 10 and 11 show the dispenser outlet 21 at the extremes of its movement. As the dispenser outlet 21 moves from the position shown in FIG. 10 to the position shown in FIG. 11, it causes the piston 11 to move over and cover the spill hole 20. While the spill hole 20 remains uncovered, the filler material in the body of the dispenser 10 is pushed out of the spill hole by the action of the piston 11, and at the same time the piston 11 remains in contact with the pintle 15 maintaining the dispenser outlet 21 closed. When the spill hole 20 is covered by the piston 11, backflow to the reservoir 25 through the spill hole is prevented. Backflow through the inlet 14 is also prevented by the check ball 12. Further movement of the dispenser outlet 21 causes the pressure within the dispenser body 10 to rise and to displace the piston 11 against the piston spring 18 and so to break the seal between the piston 11 and the back of the pintle 15. Filler material is now displaced through the dispenser outlet 21 for the remainder of the stroke of the dispenser to the position shown in FIG. 11. The quantity of filler material dispensed is therefore a function of the cross-sectional area of the piston 11 and the position of the spill hole 20 relative to the end of the stroke of the dispenser outlet 21. Moreover, delivery of filler material will not commence until the spill hole 20 is covered so that the first part of the stroke will not cause delivery, so that accidental contact with the dispenser outlet 21 will not give rise to delivery of the filler material.

FIG. 12 shows the dispenser body 10 connected to the reservoir 25. The reservoir is ideally constructed of a flexible, non-stretch material which can readily change its shape and volume, without pressure change, as the quantity of filler material in the reservoir changes. The flexible reservoir 25 is preferably housed within a rigid frame or container for protection.

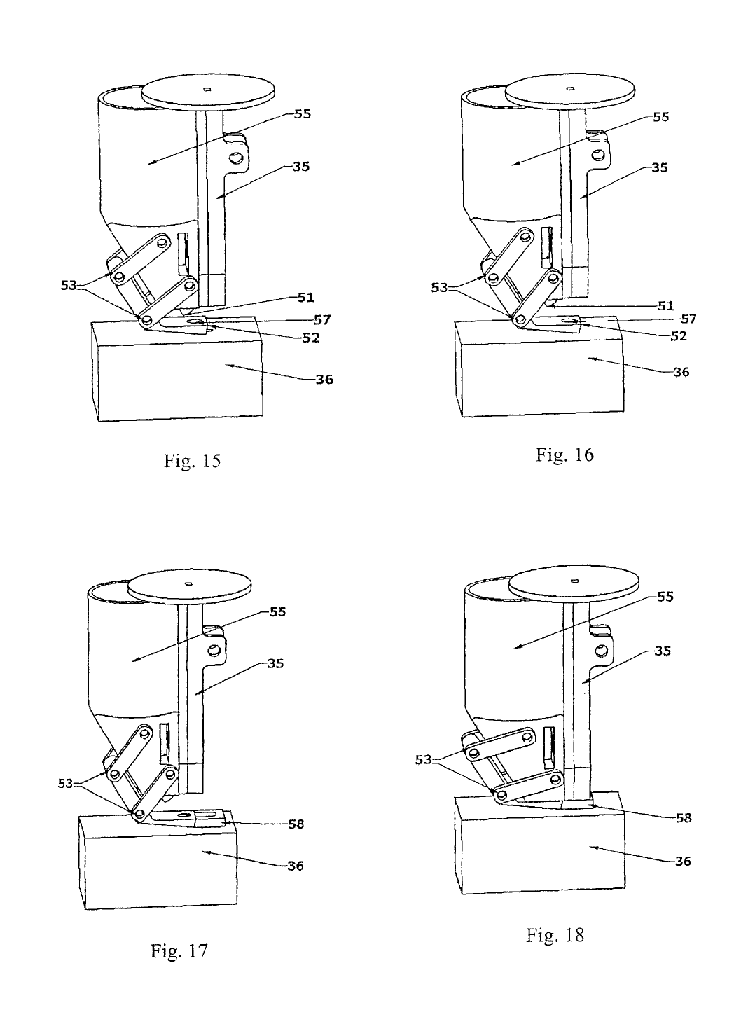

FIGS. 13 to 16 show a filler dispenser system which incorporates a wiper 52 to provide the function of the shoe 32 described in relation to FIGS. 1 to 12. The wiper 52 is supported by links 53 attached to a main body 55 of the dispenser system, which is in turn attached to a nailgun barrel 35. The geometry of the links 53 and the wiper 52 constrain a leading edge of the wiper to follow an arcuate path approximating to the axis of the dispenser 10. The wiper 52 is spring loaded to the extreme position shown in FIG. 16. As the nailgun approaches the wooden block 36, the wiper initially contacts the surface of the wooden block 36 so that the leading edge covers the position of the nail site 31. As the nailgun is brought closer to a position corresponding to FIGS. 10 and 11, the wiper 32 retracts back across and away from the nail site 31 and the inner surface of the wiper 52 contacts a dispenser nozzle 51 in a recess 57. Further motion of the nailgun to the position of FIG. 13 causes dispenser nozzle 51 to depress and deliver a quantity of filler material to the surface of the wooden block 36 from the recess 57 in the wiper 52 via a connecting channel. The nailgun, in the configuration of FIG. 13, is ready to fire and the interlocking trigger on the foot 44 (not shown in FIG. 13) Is connected. After the nail has been fired through the filler material, the nailgun lifts away from the surface of the wooden block 36 in a direction perpendicular to the surface and the wiper 52 remains in contact with the surface by means of a spring (not shown). The wiper 52 moves back towards the nail site 31 and smooths the filler material into the depression caused by the nailing action at the nail site 31. It is intended that the main body 55, the links 53 and the wiper 52, together with the dispenser and filler reservoir, might be manufactured cheaply as a disposable item, to be replaced in part or totally on exhaustion. With this design, the dispenser can be simplified to eliminate the spill hole and return passageway, since the stroke can be much shorter as it is not required for the smoothing action.

FIGS. 17 to 19 illustrate the fitting of a flexible guard 58 to the wiper 52. The flexible guard 58, together with the wiper 52, surrounds the filler material on the surface of the wooden block 36 at the point when the nail is fired. The flexible guard 58 contains the filler material and prevents splatter as the nail penetrates the filler material at high speed. The flexible guard can be part of the disposable system previously described.

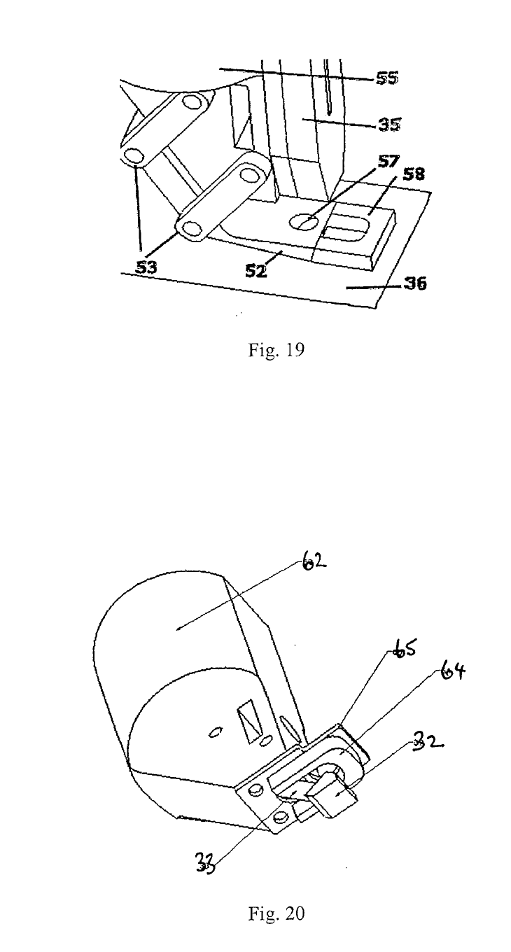

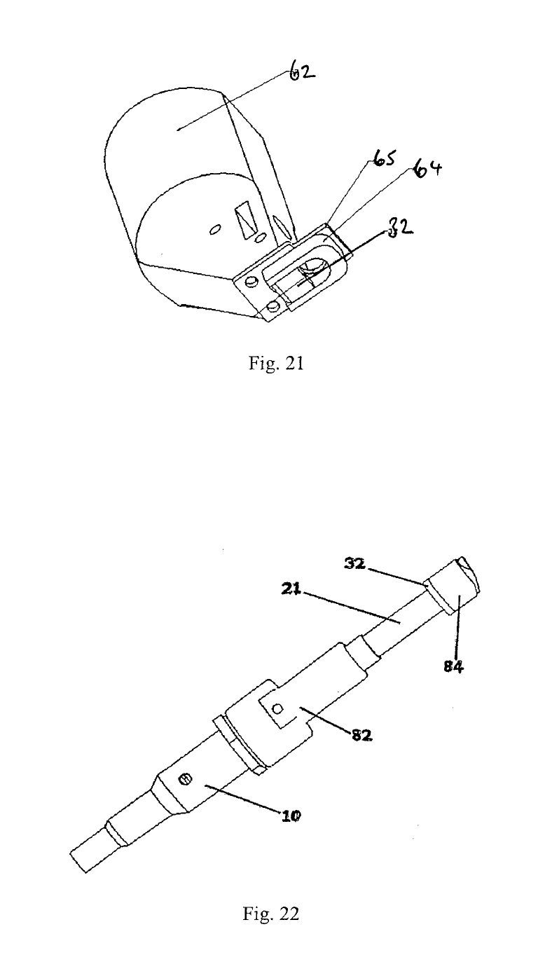

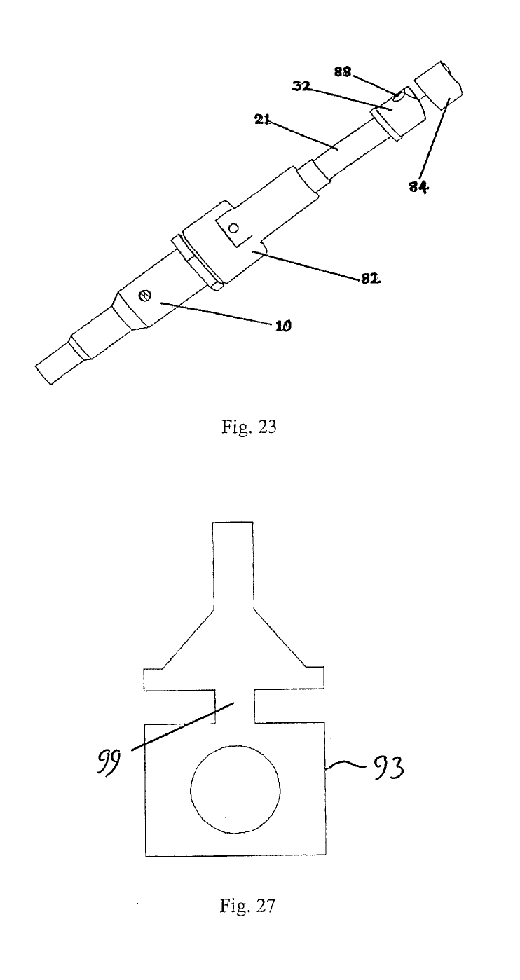

FIGS. 20 and 21 illustrate a guard system for the dispenser system described in relation to FIGS. 1 to 12. A splatter guard 64 is mounted on a bracket 65 attached to a filler dispenser body 62. These components, together with the dispenser, reservoir and filler material, might form part of a disposable system.

The shoe 32 on the dispenser nozzle 34 forms an infill between the open ends of the substantially C-shaped splatter guard when the dispenser nozzle 34 is in its fully depressed position. As the nailgun is fired and the nail impacts with the filler material, the splatter guard forms a complete seal around the nail site 31 against the surface of the wooden block 36.

FIGS. 22 and 23 show a simple sealing system that acts as a one-way valve to prevent the filler material hardening in the dispenser during periods when not in use. The figures represent the dispenser body 10 attached to a fixing armature 82 through which the dispenser outlet 21 is attached to shoe 32. In this arrangement the shoe is substantially cylindrical with an orifice 88 in the side wall, through which the filler material is delivered. An elastic sleeve 84 is slipped on the cylindrical surface of the shoe 32 so that the material of the elastic sleeve 84 is in tension. Positive pressure from the inside of the shoe 32 will cause the sleeve to lift from the surface of the shoe and allow filler material out. Air, dirt and moisture are prevented from entering the orifice 88 and low pressure vapors from volatile constituents of the filler material cannot escape through the orifice, thus preventing premature hardening of the filler material.

Various modifications may be made without departing from the invention. For example, the dispenser might employ different valves and piston design or the splatter guard system might be permanently affixed to the nailgun barrel.

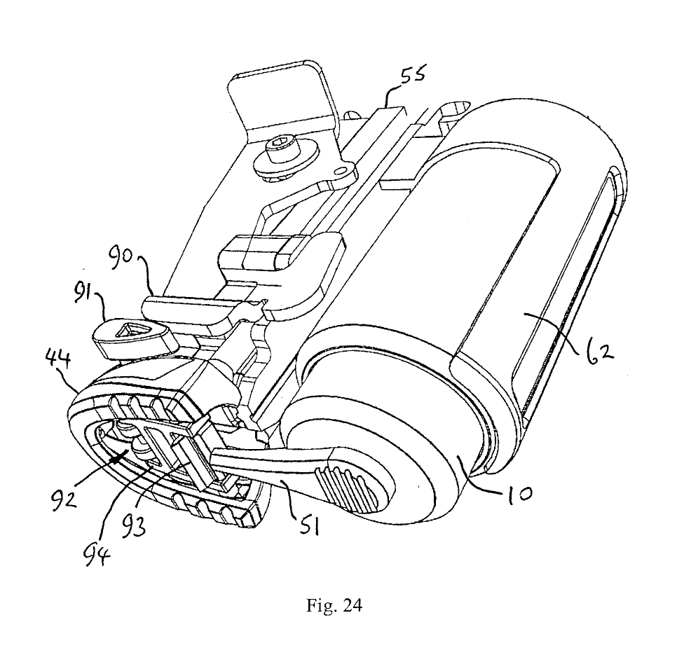

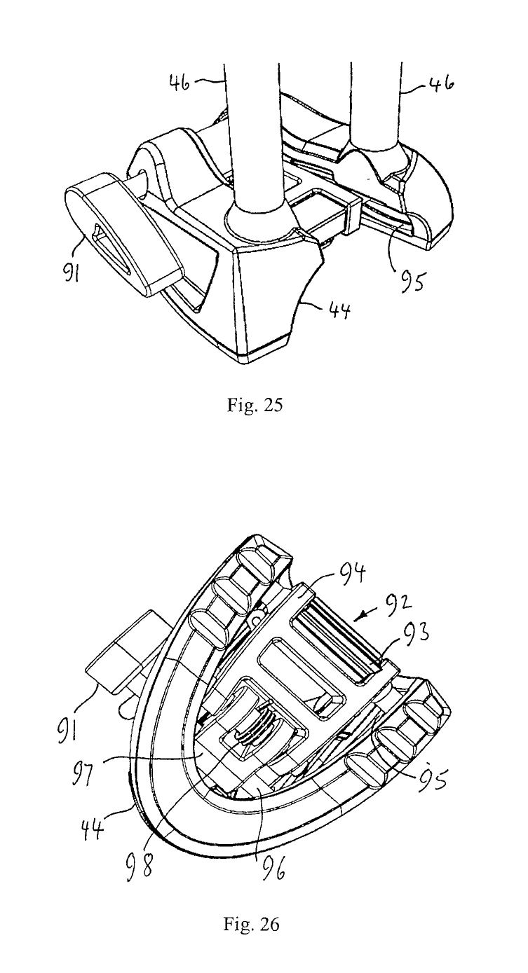

The nailgun shown in FIGS. 24 to 27 includes a dispenser 10 having a nozzle 51 and mounted within a dispenser body 62. The nozzle 51 is configured such that, as the nailgun is operated by movement towards a work surface (not shown) the nozzle engages against the work surface and causes the dispenser 10 to retract into the dispenser body 62 so as to dispense a predetermined volume of filler onto the work surface in the path of a nail (not shown).

A foot 44 is mounted on supports 46 which extend upwardly to a body of the nailgun in conventional manner. As explained previously, the foot 44 is movable relative to the body of the nailgun and is biased towards an extended position. As the foot is caused to retract as a result of contact with the work surface a second, interlocking trigger mechanism (not shown) is conventionally provided as part of the actuating mechanism for the nailgun.

A cam actuator 90 is provided on the body 55 of the nailgun in a predetermined position so as to engage with a cam 91 provided on the foot 44 as the foot is retracted. The foot 44 is substantially U-shaped in configuration so as to substantially surround a region on the work surface into which the nail is to be inserted. The lower face of the foot 44 is provided with a non-slip surface, for example of thermoplastic elastomer having a medium to high Shore hardness, in order to ensure the nail is inserted into the intended region. The non-slip surface may be ridged to enhance grip with the work surface. If desired, the non-slip surface may be removed and replaced with fresh material to ensure a continuing satisfactory engagement with the work surface into which the nail is to be inserted. The nozzle 51 of the dispenser extends into an open side of the U-shaped foot 44 so as to dispense the filler at the desired location as the foot is retracted.

A wiper blade assembly 92 is mounted within the U-shaped foot 44 and includes a wiper blade 93 mounted on a carrier 94. The wiper blade is made of a flexible, or preferably a resilient, material having a low coefficient of friction, such as polytetrafluoroethylene (PTFE), silicone or polypropylene material, to allow the wiper blade to pass smoothly over the work piece. If desired, the wiper blade 93 may be provided with a surface coating to further reduce the coefficient of friction thereof. The wiper blade 93 will tend to wear as a result of repeated movement over the work surface and can be damaged, for example as a result of contact with irregularities in the work surface. The wiper blade, at least, is therefore a replaceable component which can readily be removed and replaced with a new component whenever necessary. The wiper blade 93 may be mounted on the wiper blade assembly 92 by way of biasing means, such as a coil spring or a torsion spring, to urge the free edge of the wiper blade in the direction of the work surface.

The carrier is mounted within the foot 44 in a slidable manner, for example in recesses 95 which allow the carrier to move generally laterally towards and away from the dispenser nozzle 51. The recesses 95 extend substantially laterally in the region thereof closest to the dispenser nozzle 51, but are inclined upwards (away from the work surface) at each end. This results in the wiper blade being lifted at least partially from the work surface at each end of its travel. Such an action may conveniently be obtained by movement along a curved, or arcuate, path.

The cam 91 is mounted on a rotatable shaft 96 which passes through the foot 44. Also mounted on the rotatable shaft, within the foot 44, so as to be rotatable in response to rotation of the cam is one end of an operating arm 97. The other end of the operating arm 97 is rotatably connected to the carrier 94. Biasing means, such as a torsion spring 98 as illustrated or a coil spring, may be provided to bias the carrier 94, and therefore the wiper blade 93, in a direction towards the dispenser nozzle 51.

As can be seen from FIG. 27, the wiper blade 93 may be formed with a waisted region 99 which facilitates flexing of the wiper blade.

In use of the nailgun shown in FIGS. 24 to 27, as a user pushes the nailgun towards a work surface in a direction substantially perpendicular to the surface the cam actuator 90 engages with the cam 91 and causes the cam to rotate in a clockwise direction in FIG. 24. Rotation of the cam 91 causes corresponding rotation of the shaft 96 and the operating arm 97 to move the carrier 94 and attached wiper blade 93 away from the dispenser nozzle 51 and to lift the wiper blade 93 at least partially from the work surface at the end of its range of travel.

At the same time, the dispenser nozzle 51 contacts the work surface and is depressed so as to dispense a predetermined amount of filler in the form of a bead onto the work surface in the region where the nail is to be inserted.

When the nailgun has been moved to within a predetermined distance of the work surface with the foot 44 in contact with the surface, the nailgun is primed and a nail is fired by depressing a conventional trigger (not shown). The nail travels out of the nailgun and passes into the work surface through the bead of filler material drawing a portion of the filler material into the work surface.

The user then lifts the nailgun away from the work surface in a direction substantially perpendicular to the surface and the cam actuator 90 is retracted so as to allow the cam 91 to rotate under the biasing force of the torsion spring 98 so as to move the carrier 94 and the wiper blade 93 towards the dispenser nozzle 51 and again to lift the wiper blade 93 at least partially from the work surface at the end of its range of travel.

As the wiper blade 93 moves towards the dispenser nozzle 51 the carrier 94 runs along the recesses 95 so as to approach the work surface as well as moving towards the dispenser nozzle. The downward movement, combined with flexing of the wiper blade 93 in the region of the waist thereof so that the wiper blade is angled (i.e., not substantially perpendicular) to the work surface, creates a “smearing” action which first pushes filler material in a downwardly direction into the depression created by the nail head as it entered the work surface and then removes excess filler material which remains proud of the depression.

The lifting motion of the wiper blade 93 at the ends of its range of travel, combined with the flexibility resulting from the waisted region, allows the wiper blade readily to ‘flip’ from one angled direction to the other when changing direction of movement at the end of each direction of travel and allows the wiper blade to pass more easily over the work surface without catching on any irregularities. That is, the waisted region 99 acts as a form of hinge. Thus the lower edge of the wiper blade 93 is always trailing behind the upper region thereof irrespective of the direction of movement.

It will be appreciated that the use of a cam 91 and operating arm 97 is not essential and that alternative mechanisms can be used to transmit the downward motion of the nailgun into transverse movement of the wiper blade assembly 92, such as a rack and pinion assembly or a worm drive. Moreover, the wiper blade 93 may additionally or alternatively be pivotable, for example around the lower edge thereof, so as to engage the filler material with a face of the blade and to urge the filler material into the depression in the work surface caused by the head of the nail. Alternatively, the wiper blade may be replaced by other means, such as a downwardly biased roller or the like to urge filler material into the depression in the work surface caused by the head of the nail.

1. A gun device for driving a fixing element into a work surface and including a driving mechanism for driving a fixing element into the work surface, wherein the gun device further includes:
supply means for a filler material, the supply means having an outlet arranged to deposit filler material on the work surface at a point corresponding substantially to an entry point of the fixing element into the work surface;
means for actuating the supply means in response to advancement of the gun device towards the work surface to deposit filler material on the work surface, such that the fixing element, when driven into the work surface, passes through the filler material;
and means movable in response to retreat of the gun device from the work surface to pass across the work surface over the end of the fixing element so as to cause deposited filler material to smooth and fill any depression formed in the work surface as a result of operation of the gun device.

2. A device as claimed in claim 1, wherein the supply means comprises a piston pump dispenser including a body attached to the remainder of the device, piston means biased to an extended configuration, and a reservoir.

3. A device as claimed in claim 2, wherein the means for actuating the supply means comprises a shaft which protrudes from the remainder of the dispenser to contact the work surface.

4. A device as claimed in claim 3, wherein the shaft is hollow for the passage of filler material to the outlet.

5. A device as claimed in claim 2, wherein a one-way valve is incorporated into the piston to inhibit the flow of filler material from the outlet back into the supply means.

6. A device as claimed in claim 2, wherein the piston pump dispenser includes a spill port which is covered by the piston means during part of its travel such that on initial movement of the piston means the spill port is open and filler material flows back to a reservoir, while on further movement the piston means closes the spill port and filler material is dispensed through the outlet.

7. A device as claimed in claim 2, wherein the reservoir is made of a flexible material.

8. A device as claimed in claim 7, wherein the flexible reservoir is contained within a substantially rigid frame.

9. A device as claimed in claim 1, wherein the supply means is operated on advancement of the device as a result of contact with the work surface.

10. A device as claimed in claim 1, wherein an axial direction of the outlet is inclined to a direction of movement of the fixing element from the device into the work surface.

11. A device as claimed in claim 10, wherein the axial direction of the outlet intersects with the direction of movement of the fixing element.

12. A device as claimed in claim 1, wherein the outlet of the supply means is movable in response to retreat of the gun device from the work surface so as to cause deposited filler material to fill any depression.

13. A device as claimed in claim 1, wherein the means movable in response to retreat of the device is selected from a wiper and a roller.

14. A device as claimed in claim 13, wherein the movable means is movable such that, on advancement of the device towards the work surface, the movable means is retracted from a first position in which it extends across a direction of movement of the fixing element from the device into the work surface to a second position in which the movable means is clear of the direction of movement and, on retreat of the device from the work surface, the movable means is advanced from the second position to the first position so as to cause deposited filler material to fill any depression.

15. A device as claimed in claim 14, wherein as the movable means is moved between the first and second positions the movable means is moved initially towards and subsequently away from the work surface.

16. A device as claimed in claim 15, wherein the movable means is moved along an arcuate path.

17. A device as claimed in claim 13, wherein the movable means is movable by means selected from a cam mechanism, a rack and pinion assembly and a worm drive which is operated as the device is advanced towards and retracted from the work surface.

18. A device as claimed in claim 13, wherein the movable means is made of a flexible material.

19. A device as claimed in claim 18, wherein the movable means is made of a resilient material.

20. A device as claimed in claim 18, wherein the movable means is made of a material having a low coefficient of friction.

21. A device as claimed in claim 18, wherein the movable means is coated with a material having a low coefficient of friction.

22. A device as claimed in claim 18, wherein the wiper is formed with a waisted portion to increase flexibility thereof.

23. A device as claimed in claim 13, wherein biasing means is provided to urge the movable means towards the work surface.

24. A device as claimed in claim 1, wherein the outlet incorporates a one-way valve which allows the passage of filler material under the action of internal pressure, but otherwise provides an air-tight seal.

25. A device as claimed in claim 1, wherein a guard is provided to surround the filler material deposited on the work surface.

26. A device as claimed in claim 25, characterized that the guard is at least in part flexible.

27. A device as claimed in claim 25, wherein the outlet forms part of the guard at the time the fixing element is driven into the work surface.

28. A device as claimed in claim 1, wherein the movable means is located in a movable foot of the device.

29. A device as claimed in claim 28, wherein a surface of the foot adapted to contact the work surface is provided with a non-slip surface.

30. A device as claimed in claim 28, wherein the movable foot is substantially U-shaped.

31. A device as claimed in claim 30, wherein the outlet extends into an open side of the U-shaped foot.
